(19) United States
(12) Patent Application Publication
(10) Pub. No.: US 2023/0184875 A1
(43) Pub. Date: Jun. 15, 2023

(54) POSITIONING AND TRUSTWORTHINESS

(71) Applicant: Sony Group Corporation, Tokyo (JP)

(72) Inventors: Anders BERGGREN, Lund (SE); Basuki PRIYANTO, Lund (SE); Johan HILL, Lund (SE)

(21) Appl. No.: 18/016,426

(22) PCT Filed: Jul. 28, 2021
(86) PCT No.: PCT/EP2021/071197

§ 371 Date: Jan. 16, 2023

(30) Foreign Application Priority Data
Jul. 29, 2020 (SE) 2030239-4

(51) Int. Cl. G01S 5/02; G01S 5/00

(52) U.S. Cl. CPC G01S 5/0244; G01S 5/021; G01S 5/0027

(57) ABSTRACT

A method of operating a location server node (85) to obtain positioning data (4030) from a wireless communication device (80), the positioning data (4030) being for determining a position estimate of the wireless communication device (80), the method comprising: providing a request (4015) to the wireless communication device (80) to provide the positioning data (4030) to be based on multiple positioning measurements, the request (4015) being indicative of the multiple positioning measurements to be executed within a predetermined time window, and obtaining the positioning data (4030) from the wireless communication device (80).

### TECHNICAL FIELD

Various aspects of the disclosure generally relate to positioning of a wireless communication device. Various examples of the disclosure specifically relate to implementing multiple positioning measurements to obtain a trustworthiness of the positioning.

### BACKGROUND

To position mobile devices such as wireless communication devices (sometimes also referred to as user equipment (UE)) various positioning measurements are known. Positioning measurements include cellular positioning measurements and non-cellular positioning measurements. Examples of non-cellular positioning measurements include, e.g., satellite-based positioning measurements or positioning measurements using sensors, including such as a gyroscope, an accelerometer, a barometer. Further non-cellular positioning measurements include Simultaneous Localization and Mapping (SLAM), time-of-flight ranging, etc. Non-cellular positioning measurement is also known as Radio Access Technology (RAT) independent positioning measurement. Cellular positioning measurement uses the radio signals of the cellular communication system (e.g. Long Term Evolution (LTE), 5G New Radio (NR)) that can be used for positioning measurement. It is also known as RAT dependent positioning measurement. Cellular positioning measurements can rely on the use of cell-identity tracking or positioning reference signals (PRSs). It is then possible to determine one or more of the following based on a receive property of the PRSs: a time of arrival (TOA), e.g., a time-difference of arrival or a multi-round-trip time; an angle of arrival; an angle of departure; a received signal strength. Based on such measures, it is then possible to perform multilateration or associated techniques to determine the location of the UE.

There is a general trend to provide more accurate positioning depending on the required service levels. Location-based services can require an accurate estimate of the position of the UE. For a scenario in which the position of the UE is estimated inaccurately, the functionality of the location-based service can be compromised.

### SUMMARY

Accordingly, a need exists for advanced positioning. In particular, a need exists for positioning that facilitates location-based services to execute reliably and according to the required positioning requirement.

This need is met by the features of the independent claims. The features of the dependent claims define examples.

A method of operating a location server node to obtain positioning data from a UE is provided. The positioning data is for determining a position estimate of the UE. The method includes providing a request to the UE to provide the positioning data to be based on at least one positioning measurement. Then, the positioning data can be obtained from the UE.

For example, it would be possible that the request is to provide the positioning data to be based on multiple positioning measurements. The request can be indicative of the multiple positioning measurements to be executed within a predetermined time window.

It would be possible to determine the trustworthiness of the position estimate based on the positioning data being based on the multiple positioning measurements that are executed within the predetermined time window.

Alternatively or additionally, it would be possible to obtain context data indicative of a context of the at least one positioning measurement. For example, the context data may be obtained from the UE or another node. It can be possible to determine the trustworthiness of the position estimate based on the context data.

In some examples, in a scenario in which multiple positioning measurements to be executed within the predetermined time window are used, it would be possible to provide a relative priority of the multiple positioning measurements to the UE. Thereby, comparably reliable positioning measurements may be set to a higher priority, so that the overall trustworthiness of the position estimate may benefit.

According to such techniques, it is possible to determine the trustworthiness of the position estimate. Thereby, an integrity of applications using the position estimate can be facilitated. For example, inaccurate location-based services may be avoided.

A computer program or a computer program product or a computer-readable storage medium includes program code. The program code can be loaded and executed by at least one processor. Upon executing the program code, the at least one processor performs a method of operating a location server node to obtain positioning data from a UE. The positioning data is for determining a position estimate of the UE. The method includes providing a request to the UE to provide the positioning data to be based on at least one positioning measurement. Then, the positioning data can be obtained from the UE.

A location server node includes control circuitry configured to provide a request to a UE to provide positioning data to be based on at least one positioning measurement. The control circuitry is further configured to obtain the positioning data from the UE.

A method of operating a UE to provide positioning data for determining a position estimate of the UE is provided. The method includes obtaining a request from a location server node. The request is to provide the positioning data to be based on at least one positioning measurement. Upon executing the at least one positioning measurement, the positioning data is provided to the location server node.

For illustration, the request could be for providing multiple positioning measurements to be executed within a predetermined time window. Then, the positioning data can be provided to the location server node that is indicative of the multiple positioning measurements. Alternatively, or additionally to providing such positioning data that is indicative of multiple positioning measurements, it would be possible to provide context data that is indicative of a context of the at least one positioning measurement.

A computer program or a computer program product or a computer-readable storage medium includes program code. The program code can be loaded and executed by at least one processor. Upon executing the program code, the at least one processor performs a method of operating a UE to provide positioning data for determining a position estimate of the UE. The method includes obtaining a request from a location server node. The request is to provide the positioning data to be based on at least one positioning measurement. Upon executing the at least one positioning measurement, the positioning data is provided to the location server node.

A UE includes control circuitry configured to obtain a request from a location server node. The request is to provide the positioning data to be based on at least one positioning measurement. Upon executing the at least one positioning measurement, the positioning data is provided to the location server node.

It is to be understood that the features mentioned above and those yet to be explained below may be used not only in the respective combinations indicated, but also in other combinations or in isolation without departing from the scope of the disclosure.

### BRIEF DESCRIPTION OF THE DRAWINGS

FIG. 1 schematically illustrates a communication system including a UE, base stations, and a location server node, as well as transmission of PRSs from the base stations (BS) to the UE according to various examples.

FIG. 2 schematically illustrates partial position estimates based on multiple positioning measurements in relation to a true position of the UE according to various examples.

FIG. 3 schematically illustrates partial position estimates based on multiple positioning measurements in relation to a true position of the UE according to various examples.

FIG. 4 schematically illustrates partial position estimates based on multiple positioning measurements in relation to a true position of the UE according to various examples.

FIG. 5 schematically illustrates partial position estimates based on multiple positioning measurements in relation to a true position of the UE according to various examples.

FIG. 6 schematically illustrates a location server node (LS) according to various examples.

FIG. 7 schematically illustrates a UE according various examples.

FIG. 8 is a flowchart of a method according to various examples.

FIG. 9 is a flowchart of a method according to various examples.

FIG. 10 is a signaling diagram of communication between nodes of the communication system of FIG. 1 according to various examples.

FIG. 11 illustrates execution of multiple positioning measurements within a predetermined time window according to various examples.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, examples of the invention will be described in detail with reference to the accompanying drawings. It is to be understood that the following description of examples is not to be taken in a limiting sense. The scope of the invention is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, techniques will be described for estimating a position of a mobile device (sometimes also referred to as location estimation). In particular, positioning in a communications network - e.g., a cellular network - is described. Here, the mobile device is implemented by a UE.

The techniques described herein can rely on different types of positioning measurements. Example positioning measurements are listed below in TAB. 1.

TAB. 1

Different types of positioning measurements that can be used in the various examples throughout this disclosure.

| | | |
|---|---|---|
| | Type of positioning measurement | Description |
| A | PRSs | It is possible to use uplink PRSs (e.g., synchronization reference signals, SRS, for positioning) and/or downlink PRSs, transmitted from the wireless communication device to the network, or vice versa. Based on a receive property of the PRSs, a time of arrival, round trip time, time-difference of arrival, angle of arrival, received signal strength or another signal propagation property may be derived. Based on such signal propagation property, it is then possible to estimate a position of the wireless communication device. As a general rule, instead of using dedicated PRSs, it would also be possible to rely on other |
| | | kinds of reference signals, e.g., synchronization reference signals. |
| B | Satellite-based positioning | Based on a multilateration method, receiving as an input the time delay of signals transmitted by satellites, it is possible to estimate a position of the UE. |
| C | Ultra-wideband positioning | Beacons can emit ultra-wideband positioning signals and based on such signal propagation properties, it is possible to estimate a position of the UE. |
| D | Gyroscope | An internal sensor of the UE can be used for odom-etry. The gyroscope can implement an example of an inertial measurement unit (IMU) and, as a general rule, other kinds and types of inertial measurement units could be used to determine the position estimate. |
| E | Wi-Fi beacon | It is possible to listen to IEEE 802.11x beacon signals and then map the respective identity to a respective database. |
| F | Bluetooth beacon | Similar to Wi-Fi beacons as in example E, but with reference to Bluetooth beacons according to IEEE 802.15. |
| G | Cellular beacons | It is possible to listen for beacon signals transmitted by cellular BSs and then map respective identities to a respective database. |
| H | Fingerprinting | Signal properties of the electromagnetic spectrum can be looked up in a fingerprinting database to estimate the position of the UE. |

As a general rule, the distribution of logic between the communications network and the UE with respect to the positioning can differ according to the implementation. Two examples are described below in TAB. 2.

TAB. 2

Network-based positioning and UE-based positioning and associated information content of the positioning data. According to the various examples described herein, both options are conceivable.

| | |
|---|---|
| Determining of the position estimate at... | Description |
| ...the network. | Network-based positioning: here, positioning data is provided to the communications network, e.g., a LS, which does not explicitly indicate the final position estimate. For instance, the LS may aggregate positioning data from multiple sources, e.g., from multiple BSs having received uplink PRSs from the UE. Then, based on the positioning data, the position estimate is determined at the LS. |
| ... the UE. | UE-based positioning: here, the result of the positioning measurement is postprocessed at the UE to determine the position estimate. Then, the position estimate is used by the UE itself or reported to the communications network, e.g., a LS. The postprocessing required at the LS is reduced if compared to a network-based positioning, as discussed above. |

Hereinafter, techniques are described for illustrative purposes in the context of an implementation of the communications network as a Third Generation Partnership Project (3GPP) cellular network, e.g., according to the Long Term Evolution (LTE) protocol according or the New Radio (NR) protocol. These are examples only in other implementations are conceivable.

Various techniques are based on the finding that it can often be helpful to determine a trustworthiness of the estimated position of the UE. The trustworthiness can describe a level of integrity or reliability of the position estimate. For instance, trustworthiness could indicate whether a subsequent location-based service is expected to operate accurately or whether the integrity of the location-based service can be compromised by a position estimate of low quality. For example, the trustworthiness of the position estimate could be indicated in binary form, e.g., as “trustworthy” versus “not trustworthy”. It would also be possible that the trustworthiness is determined quantitatively, e.g., in terms of an error or tolerance associated with the position estimate, e.g., in meters or centimeters. The trustworthiness can correspond to the integrity as the measure of trust that can be placed in the correctness of the position estimate.

Various techniques are based on the finding that it can be helpful to have a trustworthy position estimate for fulfilling an intended service level. According to the techniques described herein, determining of the trustworthiness of the position estimate is facilitated.

According to various examples described herein, different strategies for facilitating determining of the trustworthiness of the position estimate are conceivable. Such strategies are summarized below in TAB. 3.

TAB. 3

Example strategies for providing a data basis for determining the trustworthiness. Such strategies can be used in isolation or in combination. As a general rule, the trustworthiness can be determined at the UE or a node of the communications network. For instance, the trustworthiness can be determined at a LS of the communications network. The UE may report the context data and/or may provide the positioning data to the LS.

| | | |
|---|---|---|
| | Trustworthiness determined based on | Description |
| A | Multiple positioning measurements | In one example, it is possible to obtain positioning data based on multiple positioning measurements that measure the position of the UE at a given location. Thus, — in view of UE mobility — the multiple positioning measurements can be executed within a predetermined time window. The |
| | | predetermined time window could be indicated by the cellular network. For example, the predetermined time window could be indicated by a request to perform the multiple positioning measurements transmitted to the UE, e.g., from the LS. The predetermined time window could be specified in explicit terms or could be specified in a parametrized manner, e.g., depending on a mobility level of the UE. For instance, the multiple positioning measurements may have multiple types as described above in connection with TAB. 1. Alternatively, or additionally, the multiple positioning measurements may be executed at different points in time within the predetermined time window. In such a scenario, it would be possible to determine the trustworthiness of the position estimate based on a variability of the positioning data being based on multiple positioning measurements. The variability of the positioning data can be obtained from a comparison of respective partial position estimates determined on the basis of specific parts of the positioning data that are associated with the individual positioning measurement. In other words, a spread or distribution of the positioning data can be considered. The positioning data can include reports on the multiple positioning measurements. For example, a report message of a positioning protocol can include the reports on the multiple positioning measurements. This is applicable for TAB. 2, scenario A. For TAB. 2, scenario B, the positioning data can include partial position estimates determined based on positioning data associated with different ones of the multiple positioning measurements. |
| B | Context data for at least one positioning measurement | In a further example, the determining of the trustworthiness can be facilitated by providing context data indicative of a context of one or more positioning measurements of the multiple positioning measurements. Then, the trustworthiness can be determined based on such context data. The context data can generally describe attributes of the measurement context of the respective positioning measurement. These attributes can relate to factors influencing an accuracy of the positioning measurements. For instance, depending on the particular type of positioning measurement (cf. TAB. 1), different attributes affecting the accuracy of the positioning measurement are conceivable. For illustration, for a satellite-based positioning measurement, the amount of satellites within range would affect the accuracy of the positioning measurement. For odometry-based positioning measurements, the time since obtaining an absolute reference would affect the accuracy of the positioning measurement. For ultra-wideband based positioning measurements, the amount of beacon transmitters used would affect the accuracy of the positioning measurement. These are just a few examples and other examples are conceivable. More generally, the context data can be indicative of one or more error sources of the at least one positioning measurement. This would mean that the context data can be indicative of known sources of errors that tend to reduce the trustworthiness. Based on such context data, it is possible to determine the trustworthiness. Another attribute affecting the trustworthiness can lie in the time variance of the multiple measurements with respect to the predetermined time window - this time variance can be indicated as part of the context data. For instance, it |
| | | would be conceivable that all positioning measurements are taken within a small fraction of the overall predetermined time window, e.g., contemporaneously or at least in fast succession. Then, a relative movement of the UE in between the multiple positioning measurements is unlikely or absent. Differently, it would be conceivable that the multiple positioning measurements are taken at points in time spread out across the predetermined time window. Here, an impact on the relative movement of the UE on the results of the positioning measurements can be significant. Accordingly, the trustworthiness can be reduced. According to various examples, it would be conceivable that the UE reports such context data to the communications network. This can be in accordance with a predefined reporting scheme that can be provided by the communications network. For instance, it would be possible to report on the context data together with providing positioning data to the communications network. For instance, a predefined codebook for reporting on the context data can be provided in reference can be made to the codebook in a corresponding message that is indicative of the context data, to reduce the control-signaling overhead required to accommodate the context data. |

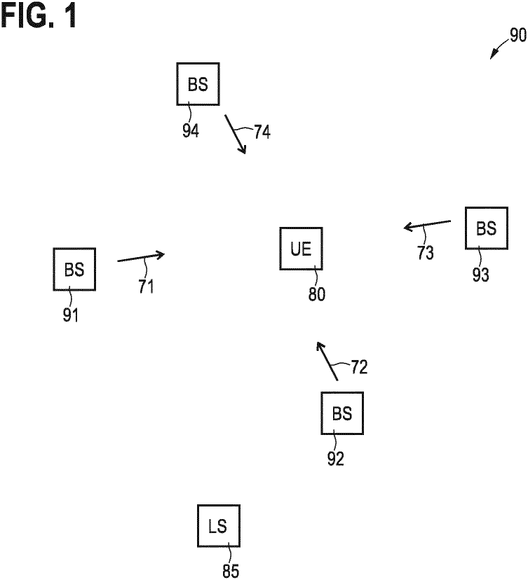

FIG. 1 schematically illustrates aspects with respect to a communications system 90 including multiple nodes. The communications system 90 includes a UE 80 and multiple BSs 91-94 of a radio-access network of a cellular network. An LS 85 is provided. The LS 85 and the UE 80 can communicate using a positioning protocol (PP). Messages of the positioning protocol can be delivered via the radio-access network.

FIG. 1 also illustrates aspects with respect to a PRS-based positioning measurement (cf. TAB. 1: example A). The BSs 91-94 transmit PRSs 71-74. For example, the transmission of the PRSs may be configured by the LS 85 using the positioning protocol. The PRSs may be transmitted at positioning occasions. The UE 80 can attempt to receive the PRSs 71-74. Then, the UE could estimate its position and include the position estimate in positioning data provided to the LS 85 (cf. TAB. 2: UE-based positioning) or report one or more signal propagation characteristics of the PRS 71-74 to the LS 85 in respective positioning data, so that the LS 85 can estimate the position of the UE 80 (cf. TAB. 2: network-based positioning). Such PRS-based positioning measurements can be re-executed at multiple points in time (e.g., multiple times within a positioning occasion or at multiple positioning occasions), to obtain multiple positioning measurements. Alternatively, or additionally, it would be possible to execute further types of positioning measurements (cf. TAB. 1), to obtain multiple positioning measurements.

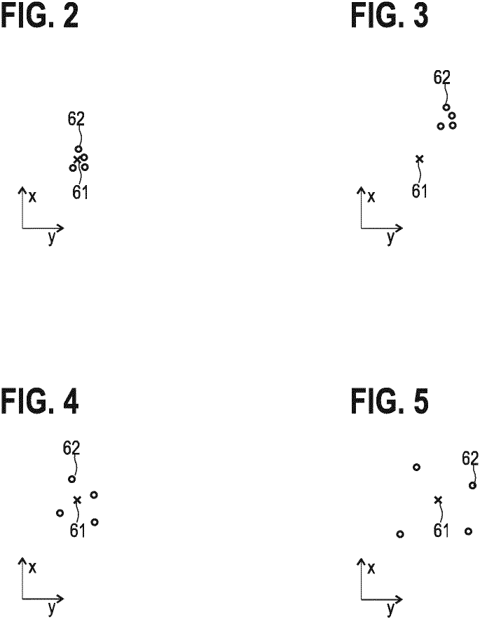

FIG. 2 - FIG. 5 illustrates aspects in connection with the trustworthiness of the position estimate of the UE determined based on multiple positioning measurements. In the scenarios shown in FIG. 2 - FIG. 5, four position estimates 62 (indicated by the circles) are determined based on respective positioning data associated with four positioning measurements. The four positioning measurements are executed within a predetermined time window. Thus, it can be assumed that their captured observables are all associated with the same true position 61 of the UE 80 (the true position 61 is illustrated with the cross). The position estimates 62 differ to a smaller or larger degree from the true position 61 in the scenarios of FIG. 2 - FIG. 5.

FIG. 2 corresponds to a scenario of high trustworthiness. Here, the position estimates 62 do not exhibit a significant systematic error and only a small statistical variation around the true position 61. On the other hand, in the scenario FIG. 3, a limited trustworthiness is encountered, because the position estimates 62 show a significant systematic error. The trustworthiness is also limited in the scenario FIG. 4 where a small systematic error is observed, but a medium statistical variation around the true position 61 is present. The statistical variation increases further in the scenario FIG. 5. It would be possible to summarize the scenario of FIG. 2 as “high accuracy and high precision”; the scenario FIG. 3 as “low accuracy and high precision”, the scenario FIG. 4 as “high accuracy and low precision”, and the scenario FIG. 5 as “low accuracy and low precision”.

For instance, it would be possible to express trustworthiness in terms of integrity levels. Then, FIG. 2 can have a level I integrity level, FIG. 3 can have a level II integrity level, FIG. 4 has a level III integrity level, and FIG. 5 has a level IV integrity level.

Depending on the particular type of positioning measurement, various sources of errors are conceivable that result in a reduced trustworthiness according to a scenario FIG. 3-FIG. 5. Details with respect to the error sources are discussed below.

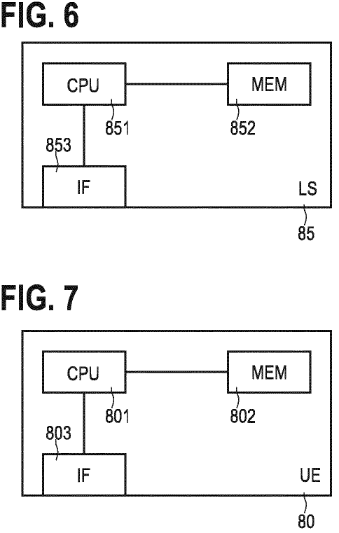

FIG. 6 schematically illustrates aspects with respect to the LS 85. The LS 85 includes a processor 851 and a memory 852. The processor 851 and the memory 852 together implement a control circuitry. The LS 85 also includes an interface 853. The LS 85 can communicate using a positioning protocol via the interface 853. An example implementation of the positioning protocol is described by 3GPP Technical Specification 37.355, version 16.0.0. For example, a RequestLocationInformation message may be transmitted that requests the UE 80 to perform multiple positioning measurements; this message can include an indicator that requests the multiple positioning measurements to be performed within a certain predetermined time window. A ProvideLocationInformation message may be received via the interface 853 and positioning data based on multiple positioning measurements may be indicated by this message. A RequestCapabilities message may be transmitted to request whether the UE is capable of performing multiple positioning measurements within a predetermined time window. The processor 851 can load program code from the memory 852 and then execute the program code. Upon loading and executing the program code, the processor 851 can perform techniques as described herein, e.g., providing a request to the UE 80 to provide positioning data based on multiple positioning measurement; determining a time window during which the multiple positioning measurements are to be executed; determining a position estimate of the UE based on the positioning data being based on the multiple positioning measurement; determining a trustworthiness of the position estimate; providing, to the UE, a configuration of a relative priority of multiple positioning measurement; etc..

FIG. 7 illustrates aspects with respect to the UE 80. The UE includes a processor 801 and a memory 802. The processor 801 together with the memory 802 form a control circuitry. The UE also includes an interface 803. The UE can communicate using the positioning protocol, as explained above in connection with FIG. 6, via the interface 803. The UE 80 can access a radio link of a radio access network of a cellular communications network via the interface 803. The processor 801 can load and execute program code from the memory 802. Upon loading and executing the program code, the processor 801 performs techniques as described herein, e.g.: obtaining a request from the LS 85 to provide positioning data based on multiple positioning measurements; providing the positioning data to the LS; obtaining a configuration of a relative priority of the multiple positioning measurements; executing the multiple positioning measurements, e.g., within a predetermined time window, etc..

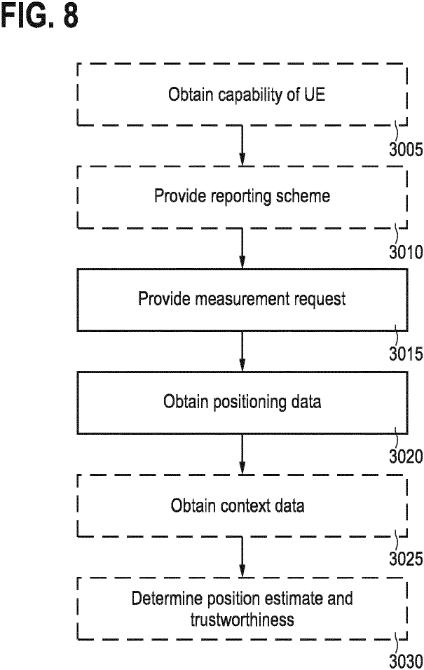

FIG. 8 is a flowchart of a method according the various examples. Optional boxes are labelled with dashed lines in FIG. 8. The method of FIG. 8 can be executed by a node of a communications network. For instance, the method of FIG. 8 may be executed by the LS 85. Specifically, it would be possible that the processor 851 of the LS 85 executes the method of FIG. 8 upon loading program code from the memory 852. Hereinafter, for the sake of simplicity, the method according to FIG. 8 is explained for an implementation on the LS 85, but respective techniques can be readily applied to scenarios in which other nodes implement this method.

At optional box 3005, the LS 85 obtains a capability from the UE 80. The capability is associated with executing multiple positioning measurements. For instance, a timing capability may be obtained that is associated with the multiple positioning measurements. The timing capability can indicate constraints of the UE 80 to execute multiple positioning measurements in quick succession. For example, the UE 80 could provide its capability with respect to a minimum processing time of possible multiple positioning measurements. For example, high-performance UEs can have a small minimum processing time, due to their capability to perform parallel tasking. On the other hand, low performance UEs will have a larger minimum processing time.

The capability of the UE obtained at box 3005 may be included in a message communicated in accordance with a positioning protocol. The UE may provide the capability upon a preceding request from the LS 85.

It is then possible that a predetermined time window during which the UE 80 is to execute multiple positioning measurements, in accordance with the capability, is obtained at box 3005. For example, the LS 85 can determine the time window depending on the capability obtained at box 3005.

Next, at optional box 3010, a reporting scheme for context data can be provided to the UE 80, e.g., again using the positioning protocol. The reporting scheme can define certain properties associated with the reporting of positioning data associated with the multiple positioning measurements. For instance, the reporting scheme could specify that the positioning data is provided in an ordered sequence, depending on a priority order of the positioning measurements. The reporting scheme could be indicative of a codebook to use when reporting the context data. The reporting scheme could specify one or more candidate error sources to be reported in the context data. For illustration, it would be possible that the LS 85 provides possible sources of errors, e.g., a respective list of sources of errors for each type of positioning measurement (cf. TAB. 1). It would also be possible to provide a generic list of sources of errors that does not depend on the particular positioning measurement to be executed. Such information can assist the UE 80 in executing the positioning measurements and the subsequent reporting thereon. Then, later on, the context data can be obtained at box 3025 in accordance with the reporting scheme.

At box 3015, a request is provided to the UE 80 to provide the positioning data that is to be based on multiple positioning measurements. It would be possible that the request is indicative of multiple positioning measurements to be executed within a predetermined time window; e.g., a respective indicator may indicate this time-domain constraint of the execution of the positioning measurement. The positioning data that is based on the multiple positioning measurements is then obtained at box 3020.

As a general rule, it would be possible that the request provided at box 3015 is indicative of the predetermined time window. In other scenarios, it would also be possible that the predetermined time window is fixed, e.g., according to the communications protocol.

For illustration, the request could define a threshold duration of the predetermined time window. The threshold duration can correspond to a maximum duration during which the UE is to perform the multiple positioning measurements. A corresponding measurement gap may be defined with respect to an ongoing data transmission.

Alternatively, or additionally, the measurement request of box 3015 could specify a starting time of the predetermined time window. For example, a number of time unit (e.g. subframe or slot) defined in the transmission protocol of the radio-access network may be specified. For example, a certain positioning occasion may be specified. In other examples, it would be possible that the starting time of the predetermined time window is predefined. For instance, it could be predefined that the UE 80 is to start executing the multiple positioning measurements as soon as possible upon receiving the measurement request at box 3015.

Such signaling of the starting time of the predetermined time window or other properties of the predetermined time window using the measurement request of box 3015 is generally optional. For illustration, it would be possible that the one or more properties are predefined with respect to the signaling of the measurement request, e.g., fixed according to the communication standard. Also, it would be possible that a separate control message is transmitted - e.g., as part of a configuration routine at connection setup - that is indicative of one or more properties of the predetermined time window.

In some examples, it would be possible that the measurement request - or another control message, e.g., communicated according to the positioning protocol - provides, to the UE 80, a configuration of a relative priority of the multiple positioning measurements. Thereby, the LS 85 can have control on the execution of the positioning measurement to be implemented at the UE 80.

As a general rule, different implementations of the relative priority are conceivable. For instance, it would be possible that the relative priority selects or does not select each one of multiple positioning measurements from a plurality of candidate positioning measurements. This means that in a scenario in which multiple candidate positioning measurements - e.g., of different type, cf. TAB. 1 - are available, some of these are activated and some of these are not activated. In a further implementation, would be possible that the relative priority defines a sequence of the execution of the multiple positioning measurements. This means that the LS can specify a sequence with which the multiple positioning measurements are executed. For instance, it would be conceivable that such positioning measurements that are considered to have a higher trustworthiness are executed before other positioning measurements are executed that are considered to have a lower trustworthiness. Alternatively, or additionally, it would also be possible that the relative priority defines a reporting priority of the positioning data that is based on the multiple positioning measurements. This means that it would be conceivable that the LS specifies which positioning measurements are first reported on. This could be again implemented in accordance with the expected effect on the trustworthiness of the overall position estimation. The relative priority can also define a reporting scheme.

An example relative priority would look as follows: downlink time difference of arrival -downlink angle of arrival - round-trip time - cell identity - satellite-based positioning -Bluetooth-based positioning - Wi-Fi-based positioning - inertial measurement unit-based positioning. For illustration, separate relative priorities may be provided for cellular-based positioning measurements and non-cellular positioning measurements. Then, the UE may select the highest-priority positioning measurements from both lists.

Upon receiving the measurement request, the UE can then perform the positioning measurements in accordance with the measurement request. For example, the starting time of the positioning measurements can be influenced by UE conditions such as CPU load and/or availability of positioning resources, e.g., PRSs for downlink positioning and synchronization reference signals for uplink positioning.

Then, the UE reports on an outcome of the positioning measurements and the LS 85 obtains the positioning data at box 3020.

At optional box 3025, it would be possible that the LS 85 obtains context data associated with the positioning data. Details with respect to the context data have been explained in connection with TAB. 3. For instance, the context data could be indicative of a time variance of the multiple positioning measurements with respect to the predetermined time window, e.g., as indicated by the measurement request of box 3015. For instance, it would be possible that the UE indicates whether the positioning measurements have been executed within the predetermined time window or whether the time variance is longer than the duration of the predetermined time window. It would be possible that the UE indicates a distribution in the time domain of the points in time of execution of the positioning measurements. In some scenarios, the UE 80 can only provide positioning data based on such positioning measurements that have been executed within the predetermined time window; other positioning data can be discarded at the UE 80. Alternatively, any positioning measurements beyond the predetermined time window may not be performed by the UE.

The context data optionally obtained at box 3025 can - alternatively or additionally - also be indicative of possible sources of positioning errors. Possible sources of positioning errors include: high velocity, low signal-to-noise ratio, UE computation conditions such as high CPU load, high-temperature which may affect the clock, limited allocation of positioning resources, e.g., for referencing such as PRSs or synchronization reference signals. This means that a possible source of error would be a sparse resource allocation positioning resources used for PRSs. Another possible source of error would be a high computational load of the UE associated with the determination of the positioning data.

The context data may, e.g., be indicative of whether a particular error source is applicable to all positioning measurements in which the UE provides positioning data at box 3020; or whether one or more of the error sources are uniquely applicable to only a sub-fraction of all positioning measurements for which the UE provides positioning data that is obtained by the LS at box 3020.

As a general rule, depending on the distribution of logic for determining the position estimate (cf. TAB. 2), the information content of the positioning data obtained at box 3020 can vary. For example, for network-based positioning, raw measurement data of the positioning measurements may be obtained. It would also be possible to obtain values that have been derived based on the raw measurement data at the UE 80 and then further processing is used to determine the position estimate. In another example, for UE-based positioning, the positioning data can already include one or more position estimates. For example, it would be conceivable that the positioning data includes partial position estimates that have been determined by the UE based on parts of the positioning data that are based on different positioning measurements.

At optional box 3030, it is possible to determine the position estimate and/or the trustworthiness of the position estimate. The position estimate can be determined based on the positioning data obtained at box 3020. The trustworthiness can be determined based on the positioning data obtained in box 3020 and/or based on the context data obtained in box 3025, as explained in TAB. 3 above. For illustration, it would be possible that the trustworthiness of the position estimate is determined based on a variability of the positioning data being based on multiple positioning measurements. More specifically, a partial position estimate can be determined based on different parts of the positioning data. These different parts of the positioning data can be based on different ones of the multiple positioning measurements. Then, the variance of the partial position estimate can be determined and this can serve as a measure for the trustworthiness. Alternatively, or additionally, the trustworthiness can also be determined based on the context data. For illustration, where the context illustrates the time variance of the multiple positioning measurements, a higher time variance can be indicative of a lower trustworthiness. For illustration, where the context data is indicative of error sources, these error sources can be analyzed and then based on such analysis - e.g., determining an impact on a particular error source on the trustworthiness - the overall trustworthiness of the position estimate can be determined.

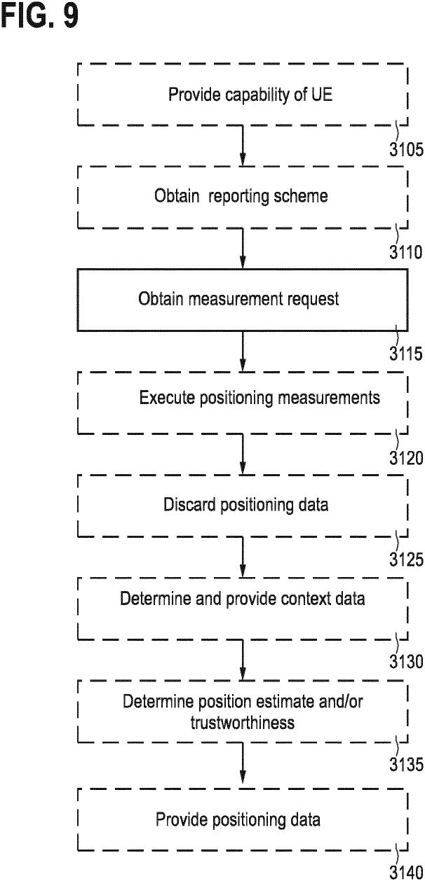

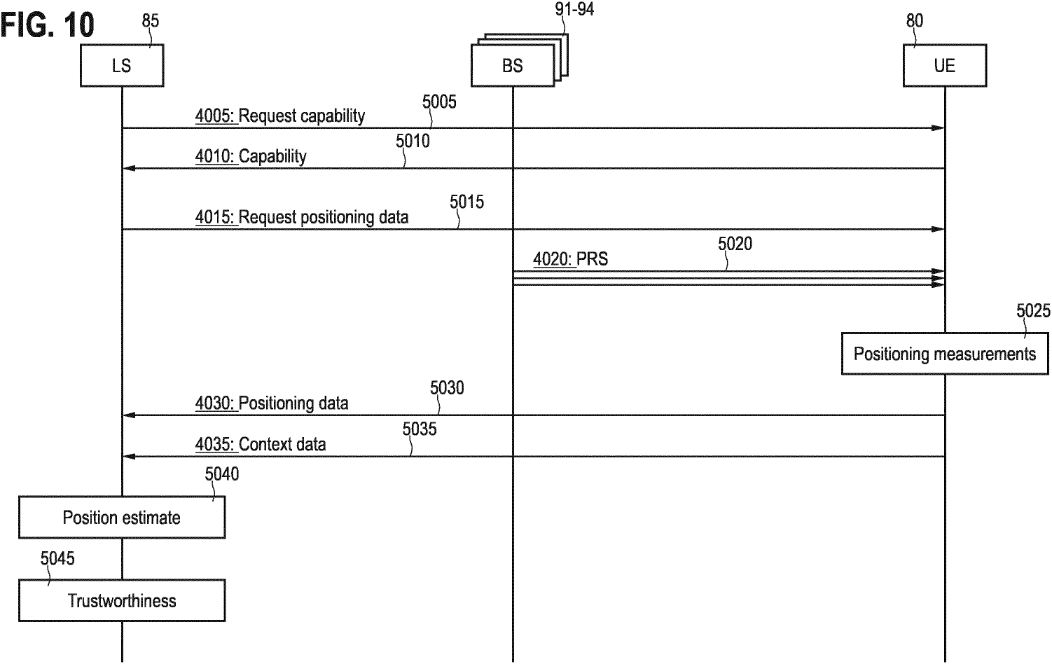

FIG. 9 is a flowchart of a method according to various examples. The method of FIG. 9 can be executed by a UE, e.g., the UE 80. More specifically, it would be possible that the method of FIG. 9 is executed by the processor 801 upon loading program code from the memory 802 and then executing the program code. Hereinafter, the method of FIG. 9 will be explained for illustrative purposes in the context of an example implementation by the UE 80. However, similar techniques may be implemented for other nodes and devices implementing the method of FIG. 9. Optional boxes are illustrated with dashed lines. The method of FIG. 9 is generally interrelated with the method of FIG. 8 in that they cooperate to facilitate positioning and determining a trustworthiness of the position estimate.

At box 3105, the UE provides a capability associated with performing multiple positioning measurements. For instance, the UE could indicate whether it is capable of executing multiple positioning measurement within a certain time window. Box 3105 is, thus, corresponding and interrelated to box 3005 of FIG. 8.

At box 3110, the UE 80 obtains a reporting scheme. The reporting scheme specifies details with respect to how to report on the result of multiple positioning measurements having been executed by the UE. Details with respect to the reporting scheme have been described in the context of box 3010 of FIG. 8.

The UE 80, next, obtains the measurement request at box 3115. The measurement request is indicative of multiple positioning measurements to be executed by the UE. For instance, the measurement request can be indicative of multiple types of positioning measurements to be executed by the UE 80 (cf. TAB. 1). It would be possible that the measurement request is indicative of the multiple positioning measurements to be executed within a predetermined time window. Box 3115 is corresponding to and interrelated to box 3015 of the method of FIG. 8.

At box 3120, multiple positioning measurements - specified by the measurement request of box 3115 - are executed. The multiple positioning measurements are executed within the predetermined time window. This means that the time-domain distance between the point in time of execution of a first of the multiple positioning measurements and the point in time of execution of a last one of the multiple positioning measurements is equal to or shorter than the length of the time window. Optionally, it would be possible to discard such positioning data that is based on one or more positioning measurements that are not executed within the predetermined time window, box 3125.

As already described in connection with FIG. 8, it would be possible to obtain, from the LS 85, a configuration of the relative priority of the multiple positioning measurements. The relative priority can define a sequence of the execution of the multiple measurements and then it is possible that, at box 3120, the multiple positioning measurements are executed in accordance with the sequence of the execution defined by the relative priority.

At optional box 3130, context data is determined for the multiple positioning measurements. The context data is indicative of the context of a least one positioning measurement of the multiple positioning measurements. The context data can be subsequently provided to the LS 85.

As a general rule, there are various options available for determining the context data at box 3130. Depending on the information content of the context data, different options for determining the context data could be implemented. For instance, it would be possible that the executing of the multiple positioning measurements is monitored so that the context data is then determined based on said monitoring. For illustration, as already explained above in connection with box 3025 of the method of FIG. 8, it would be possible that the context data is indicative of one or more error sources of the at least one positioning measurement of the multiple positioning measurements. For instance, it would be possible to monitor whether sufficient computational resources are available to accommodate for the computational load associated with the determination of the positioning data, e.g., the execution of the positioning measurements. Then the context data can be indicative of whether the computational load exceeds the available computational resources such that the accuracy of the positioning measurements can be reduced. It would be possible to monitor the points in time of execution of multiple positioning measurements and then determine whether these points in time have a large or small variance, e.g., relatively defined with respect to the predetermined time window.

For a UE-based positioning, it is possible at optional box 3135 to determine the position estimate. It would even be possible in some scenarios to determine the trustworthiness at the UE 80.

Next, at box 3140, the positioning data is provided to the LS. It would be possible that the positioning data is indicative of an outcome of the positioning measurements. For example, for UE-based positioning, the positioning data can be indicative of the position estimate and/or the trustworthiness is determined in box 3135. Box 3140 is thus corresponding to and interrelated to box 3020.

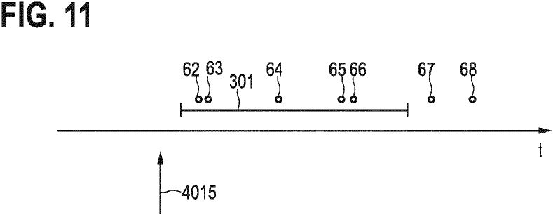

FIG. 10 is a signaling diagram of communication between the LS 85, the UE 80, and the BSs 91-94 (cf. FIG. 1). Communication to and from the LS 85 can be implemented in accordance with a positioning protocol.

At 5005, the LS 85 requests the capabilities of the UE 80 for a subsequent positioning request. The respective message 4005 can be transmitted at initial attach of the UE 80 to the LS 85, or any time before the positioning request. Message 4005 could be a RequestCapabilities message according to the positioning protocol specified in 3GPP TS 37.355, version 16.0.0.

At 5010, the UE 80 responds with its capabilities in a respective message 4010. 5010, thus, implements box 3005 of the method of FIG. 8, as well as box 3105 of the method of FIG. 9.

Then, the LS 85 triggers a location request by transmitting a corresponding request message 4015. For instance, the message 4015 could be implemented by the RequestLocationInformation message of 3GPP TS 37.355 version 16.0.0.

It would be possible that the message 4015 is indicative of a relative priority of the multiple positioning measurements. Alternatively, or additionally, the message 4015 can be indicative of the multiple positioning measurements to be executed during a predetermined time window.

In some examples, it would be possible that the message 4015 is indicative of the predetermined time window. For example, the message 4015 could define a threshold duration of the predetermined time window. Alternatively, or additionally, it would be possible that the message 4015 defines a starting time of the predetermined time window. Alternatively, or additionally, it would be possible that the message 4015 is indicative of possible sources of errors when performing multiple positioning measurements during the predetermined time window. The transmission of the message 4015 at 5015, accordingly, implements box 3015 of the method of FIG. 8 and box 3115 of the method of FIG. 9.

In the example of FIG. 10, the positioning measurements include downlink PRS based measurements. Accordingly, the BS 91-94 transmits, at 5020, PRSs 4020.

The UE 80 then, at box 5025, performs multiple positioning measurements, including the positioning measurement that is based on the PRSs 4020. It would be possible that the multiple positioning measurements are executed in accordance with the priority order as indicated by the message 4015, if applicable. Optionally, it is possible that the positioning measurements are executed at box 5025 within a predetermined time window. Details with respect to the predetermined time window illustrated in FIG. 11. FIG. 11 illustrates the predetermined time window 301. Multiple positioning measurements 62-66 are executed at points in time that are within the predetermined time window 301. The positioning measurement 67-68 are executed at points in time outside of the predetermined time window 301. Accordingly, they can be discarded, as discussed above in connection with the method of FIG. 9, box 3125. Alternatively, any positioning measurements beyond the predetermined time window may not be performed by the UE. The predetermined time window 301 is relatively aligned with respect to the point in time at which the message 4015 requesting the positioning measurements is received, as illustrated in FIG. 11. For instance, the start time of the predetermined time window 301 could be indicated by the message 4015.

Referring again to FIG. 10, next, at 5030, the UE then reports positioning data in a message 4030. The message 4030 can include the duration of the time window 301 during which the positioning measurements 62-66 have been executed. The results of the multiple positioning measurements can be included in the message 4030 in accordance with the priority order. Context data associated with the context of the multiple positioning measurements can be provided at 5035, using a message 4035. The context data could also be piggybacked to message 4030. For instance, sources of positioning errors can be reported. This can be in accordance with the reporting scheme that can be configured by the LS 85.

Then, at box 5040, the LS 85 can determine the position estimate (cf. FIG. 8: box 3030), and at box 5045 the LS 85 can determine the trustworthiness of the position estimate (cf. FIG. 8: box 3030).

Summarizing, above, techniques have been described that facilitate determining a trustworthiness of a position estimate of the UE. For this, positioning data (sometimes also referred to as location information) can be requested to be based on multiple positioning measurements that are executed within a predetermined time window and/or in accordance with a priority order. The UE can then execute the multiple positioning measurements accordingly, i.e., within the predetermined time window and/or in accordance with the priority order. The UE could define the starting time of the time window. It would be possible that the UE reports on the time variance of the multiple positioning measurements, e.g., relatively defined with respect to the predetermined time window. For instance, the UE may indicate the actual time duration during which the multiple positioning measurements have been executed, if this actual time duration is shorter than the length of the predetermined time window. The UE can also indicate sources of possible positioning errors and to what extent they can affect the positioning measurements. Based on such information it is possible to determine the trustworthiness of the position estimate. The trustworthiness of the position estimate can be used to check whether operation of a location-based service that operates based on the position estimate is compromised.

The technical effect of the techniques described herein is that the integrity of the executed positioning measurements is improved, as the LS controls which types of measurements are taken and also knows that the positioning information is recent.

Although the invention has been shown and described with respect to certain preferred examples, equivalents and modifications will occur to others skilled in the art upon the reading and understanding of the specification. The present invention includes all such equivalents and modifications and is limited only by the scope of the appended claims.

For illustration, various techniques have been described which rely on the UE reporting on multiple positioning measurements by respective positioning data, to thereby facilitate determining the trustworthiness of the position estimate. It is not required in all scenarios to use multiple positioning measurements: rather, according to some scenarios, it would be possible to facilitate determining the trustworthiness of the position estimate based on the context data, e.g., only for a single positioning measurement.

Furthermore, as a general rule, PRS may be implemented by various reference signals, e.g., synchronization reference signals for positioning use or dedicated reference signals for positioning.

1. A method of operating a location server node to obtain positioning data from a wireless communication device the positioning data being for determining a position estimate of the wireless communication device the method comprising:
providing a request to the wireless communication device to provide the positioning data to be based on multiple positioning measurements, the request being indicative of the multiple positioning measurements to be executed within a predetermined time window and
obtaining the positioning data from the wireless communication device.

2. The method of claim 1,
wherein the request is indicative of the predetermined time window.

3. The method of claim 2,
wherein the request defines a threshold duration of the predetermined time window.

4. The method of claim 2,
wherein the request defines a starting time of the predetermined time window.

5. The method of claim 2, further comprising:
obtaining, from the wireless communication device a timing capability associated with the multiple positioning measurements,
wherein the predetermined time window is in accordance with the timing capability.

6. The method of claim 1, further comprising:
obtaining, from the wireless communication device context data indicative of a context of at least one positioning measurement of the multiple positioning measurements.

7. The method of claim 6,
wherein the context data is indicative of one or more error sources of the at least one positioning measurement.

8. The method of claim 7,
wherein the one or more error sources are selected from the group comprising: high mobility level of the wireless communication device low signal-to-noise ratio of a wireless channel used to communicate positioning reference signals; high computational load of the wireless communication device associated with determination of the positioning data; sparse resource allocation of positioning resources used for positioning reference signals.

9. The method of claim 6,
wherein the context data is indicative of a time variance of the multiple positioning measurements with respect to the predetermined time window.

10. The method of claim 6, further comprising:
providing, to the wireless communication device a reporting scheme for the context data
wherein the context data is obtained in accordance with the reporting scheme.

11. The method of claim 1, further comprising:
determining a trustworthiness of the position estimate based on a variability of the positioning data being based on the multiple positioning measurements.

12. The method of claim 1, further comprising:
determining the position estimate of the wireless communication device based on the positioning data being based on the multiple positioning measurements, and
determining a trustworthiness of the position estimate based on a variance of partial position estimates, the partial position estimates being based on different parts of the positioning data the different parts of the positioning data being based on different ones of the multiple positioning measurements.

13. The method of claim 12,
wherein the trustworthiness is furthermore determined based on the context data.

14. The method of claim 1, further comprising:
providing, to the wireless communication device a configuration of a relative priority of the multiple positioning measurements.

15. The method of claim 14,
wherein the relative priority selectively selects the multiple positioning measurements from a plurality of candidate positioning measurements, and/or
wherein the relative priority defines a sequence of an execution of the multiple positioning measurements, and/or
wherein the relative priority defines a reporting priority of the positioning data being based on the multiple positioning measurements.

16. A method of operating a wireless communication device to provide positioning data for determining a position estimate of the wireless communication device the method comprising:
obtaining a request from a location server nodeto provide the positioning data to be based on multiple positioning measurements, the request being indicative of the multiple positioning measurements to be executed within a predetermined time window and
upon executing the multiple positioning measurements within the predetermined time window providing the positioning data to the location server node.

17. The method of claim 16, further comprising:
discarding further positioning data being based on one or more further positioning measurements not executed within the predetermined time window.

18. The method of claim 15, further comprising:
executing the multiple positioning measurements within the predetermined time window.

19. The method of claim 18, further comprising:
obtaining, from the location server node a configuration of a relative priority of the multiple positioning measurements, wherein the relative priority defines a sequence of an execution of the multiple positioning measurements,
wherein the multiple positioning measurements are executed in accordance with the sequence of the execution defined by the relative priority.

20. The method of claim 16, further comprising:
determining context data indicative of a context of at least one positioning measurement of the multiple positioning measurements, and
providing the context data to the location server node.

21-27. (canceled)
